(19) United States
(12) Patent Application Publication
(10) Pub. No.: US 2026/0150068 A1
(43) Pub. Date: May 28, 2026

(54) INFORMATION REPORTING METHOD AND APPARATUS, COMMUNICATION DEVICE, AND STORAGE MEDIUM

(71) Applicant: VIVO MOBILE COMMUNICATION CO., LTD., Dongguan (CN)

(72) Inventors: Sihan CHENG, Dongguan (CN); Weiwei CHONG, Dongguan (CN)

(21) Appl. No.: 19/177,787

(22) Filed: Apr. 14, 2025

Related U.S. Application Data
(63) Continuation of application No. PCT/CN2023/124289, filed on Oct. 12, 2023.

(30) Foreign Application Priority Data
Oct. 14, 2022 (CN) 202211263519.X

(51) Int. Cl. H04W 60/00; H04W 8/24

(52) U.S. Cl. CPC H04W 60/00; H04W 8/24

(57) ABSTRACT

An information reporting method and apparatus, a communication device, and a non-transitory computer-readable storage medium are disclosed in the field of communication technologies. The information reporting method includes sending, by a terminal, a registration request message to request registration, where the registration request message includes data reporting information of the terminal, and the data reporting information is used to determine a data collection policy corresponding to the terminal.

### CROSS-REFERENCE TO RELATED APPLICATIONS

This application is a bypass continuation application of International Application No. PCT/CN2023/124289, filed on Oct. 12, 2023, which claims the benefit of and priority to Chinese Patent No. 202211263519.X, filed on Oct. 14, 2022, the contents of which being incorporated by reference in their entireties herein.

### TECHNICAL FIELD

This application relates to the field of communication technologies and, more specifically, relates to an information reporting method and apparatus, a communication device, and a storage medium.

### BACKGROUND

In current network architectures and standard protocols, some network elements on a core network side may collect partial data of a terminal in a registration process of the terminal. When the core network side needs to collect a large volume of data of the terminal, a data collection policy corresponding to the terminal needs to be first determined, such that the core network side can refer to or comply with the policy when collecting the large volume of data.

### BRIEF SUMMARY

Embodiments of this application provide an information reporting method and apparatus, a communication device, and a storage medium.

According to a first aspect, an information reporting method is provided. The method includes: sending, by a terminal, a registration request message to request registration, where the registration request message includes data reporting information of the terminal, and the data reporting information is used to determine a data collection policy corresponding to the terminal.

According to a second aspect, an information reporting apparatus is provided. The apparatus includes a first sending module; and the first sending module is configured to send a registration request message to request registration, where the registration request message includes data reporting information of the information reporting apparatus, and the data reporting information is used to determine a data collection policy corresponding to the information reporting apparatus.

According to a third aspect, an information reporting method is provided. The method includes: receiving, by a first network element, a registration request message from a terminal, where the registration request message includes data reporting information of the terminal, and the data reporting information is used to determine a data collection policy corresponding to the terminal; sending, by the first network element, a first message to a second network element, and sending a second message to a third network element, where the first message includes the data reporting information, and the second message is used to request the third network element to determine the data collection policy; and sending, by the first network element, a registration response message to the terminal, where the registration response message includes the determined data collection policy.

According to a fourth aspect, an information reporting apparatus is provided. The apparatus includes a first receiving module and a second sending module; the first receiving module is configured to receive a registration request message from a terminal, where the registration request message includes data reporting information of the terminal, and the data reporting information is used to determine a data collection policy corresponding to the terminal; the second sending module is configured to: send a first message to a second network element, and send a second message to a third network element, where the first message includes the data reporting information, and the second message is used to request the third network element to determine the data collection policy; and the second sending module is further configured to send a registration response message to the terminal, where the registration response message includes the determined data collection policy.

According to a fifth aspect, an information reporting method is provided. The method includes: receiving, by a third network element, a second message from a first network element, where the second message is used to request the third network element to determine a data collection policy corresponding to a terminal; and determining, by the third network element, the data collection policy based on the obtained data reporting information of the terminal, where the data reporting information is used to determine the data collection policy.

According to a sixth aspect, an information reporting apparatus is provided. The apparatus includes a second receiving module, an obtaining module, and a determining module; the second receiving module is configured to receive a second message sent by a first network element, where the second message is used to request the information reporting apparatus to determine a data collection policy corresponding to a terminal; and the determining module is configured to determine the data collection policy based on the data reporting information of the terminal obtained by the obtaining module, where the data reporting information is used to determine the data collection policy.

According to a seventh aspect, a terminal is provided. The terminal includes a processor and a memory, the memory stores a program or an instruction that can be run on the processor, and the program or the instruction is executed by the processor to implement the steps of the method according to the first aspect.

According to an eighth aspect, a terminal is provided, including a processor and a communication interface. The communication interface is configured to send a registration request message to request registration, where the registration request message includes data reporting information of the terminal, and the data reporting information is used to determine a data collection policy corresponding to the terminal.

According to a ninth aspect, a network side device is provided. The network side device includes a processor and a memory, the memory stores a program or an instruction that can be run on the processor, and the program or the instruction is executed by the processor to implement the steps of the method according to the third aspect, or the steps of the method according to the fifth aspect.

According to a tenth aspect, a network side device is provided, including a processor and a communication interface. The communication interface is configured to receive a registration request message from a terminal, where the registration request message includes data reporting information of the terminal, and the data reporting information is used to determine a data collection policy corresponding to the terminal; send a first message to a second network element, and send a second message to a third network element, where the first message includes the data reporting information, and the second message is used to request the third network element to determine the data collection policy; and send a registration response message to the terminal, where the registration response message includes the determined data collection policy.

Alternatively, the communication interface is configured to receive a second message from a first network element, where the second message is used to request the network side device to determine a data collection policy corresponding to a terminal; and the processor is configured to determine the data collection policy based on the obtained data reporting information of the terminal, where the data reporting information is used to determine the data collection policy.

According to an eleventh aspect, a communication system is provided, including a terminal, a first network side device, and a second network side device. The terminal may be configured to execute the steps of the information reporting method according to the first aspect, the first network side device may be configured to execute the steps of the information reporting method according to the third aspect, and the second network side device may be configured to execute the steps of the information reporting method according to the fifth aspect.

According to a twelfth aspect, a non-transitory computer-readable readable storage medium is provided. The readable storage medium stores a program or an instruction, and the program or the instruction is executed by a processor to implement the steps of the method according to the first aspect, or the steps of the method according to the third aspect, or the steps of the method according to the fifth aspect.

According to a thirteenth aspect, a chip is provided. The chip includes a processor and a communication interface, the communication interface is coupled to the processor, and the processor is configured to run a program or an instruction to implement the method according to the first aspect, or the method according to the third aspect, or the method according to the fifth aspect.

According to a fourteenth aspect, a computer program/program product is provided. The computer program/program product is stored in a storage medium, and the computer program/program product is executed by at least one processor to implement the steps of the method according to the first aspect, or the steps of the method according to the third aspect, or the steps of the method according to the fifth aspect.

### BRIEF DESCRIPTION OF DRAWINGS

FIG. 1 is a schematic architecture diagram of a wireless communication system according to an embodiment of this application;

FIG. 2 is a schematic diagram of collecting data of a terminal in a registration process of the terminal;

FIG. 3 is a first flowchart of an information reporting method according to an embodiment of this application;

FIG. 4 is a second flowchart of an information reporting method according to an embodiment of this application;

FIG. 5 is a third flowchart of an information reporting method according to an embodiment of this application;

FIG. 6 is a schematic diagram of an information reporting method according to an embodiment of this application;

FIG. 7 is a first schematic structural diagram of an information reporting apparatus according to an embodiment of this application;

FIG. 8 is a second schematic structural diagram of an information reporting apparatus according to an embodiment of this application;

FIG. 9 is a third schematic structural diagram of an information reporting apparatus according to an embodiment of this application;

FIG. 10 is a schematic structural diagram of hardware of a communication device according to an embodiment of this application;

FIG. 11 is a schematic structural diagram of hardware of a terminal according to an embodiment of this application; and

FIG. 12 is a schematic structural diagram of hardware of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

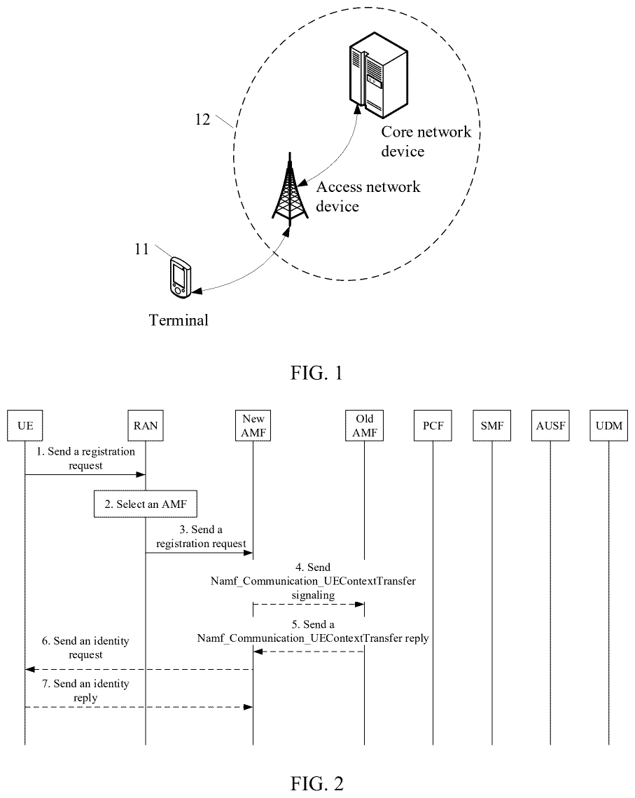

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a policy and charging rule function unit (Policy and Charging Rules Function, PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

With reference to the accompanying drawings, the following describes in detail an information reporting method and apparatus, a communication device, and a storage medium provided in the embodiments of this application by using some embodiments and application scenarios thereof.

In current network architectures and standard protocols, some network elements on a core network side may collect partial data of a terminal in a registration process of the terminal.

For example, as shown in FIG. 2, in a registration process of User Equipment (UE), a base station on a Radio Access Network (RAN) side notifies an Authentication Management Function (AMF) of Timing Advance (TA) and cell information of the UE. That is, during registration of the UE, the AMF collects partial location information of the UE. In addition, during registration of the UE, registration information that may be collected by the AMF further includes at least one of the following: registration type information (that is, registration type), a Subscription Concealed Identifier (SUCI) or a 5G Globally Unique Temporary Identifier (5G-GUTI) or a Permanent Equipment Identifier (PEI) (that is, SUCI or 5G-GUTI or PEI), a security parameter (that is, security parameters), additional GUTI information (that is, additional GUTI), 4G tracking area update information (that is, 4G Tracking Area Update), information indicating that the UE is moving from an Evolved Packet System (EPS) (that is, the indication that the UE is moving from EPS), and Public Land Mobile Network (PLMN) information with a disaster condition (that is, PLMN with Disaster Condition).

When the core network side needs to collect a large volume of data of the terminal, a data collection policy corresponding to the terminal needs to be determined first, so that the core network side can refer to or comply with the policy when collecting a large volume of data. However, the data collection policy needs to be determined based on data reporting information of the terminal (including data reporting capability information and/or data reporting preference information). Currently, because there is no solution for the terminal to report the data reporting information of the terminal, how to report the data reporting information of the terminal becomes a technical problem that needs to be urgently resolved.

To resolve the foregoing problem, in the information reporting method provided in the embodiments of the application, the terminal may send the registration request message to request registration, where the registration request message includes the data reporting information of the terminal, and the data reporting information is used to determine the data collection policy corresponding to the terminal. In this solution, the terminal may send the registration request message including the data reporting information of the terminal, to request registration. Therefore, the terminal may complete reporting of the data reporting information of the terminal during registration, so that the data reporting information of the terminal can be reported.

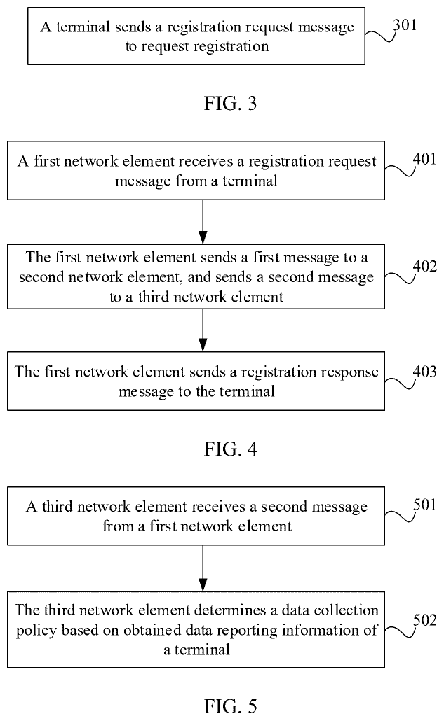

An embodiment of this application provides an information reporting method. FIG. 3 is a flowchart of an information reporting method according to an embodiment of this application. As shown in FIG. 3, the information reporting method provided in this embodiment of this application may include the following step 301.

Step 301: A terminal sends a registration request message to request registration.

In this embodiment of this application, the registration request message includes data reporting information of the terminal, and the data reporting information is used to determine a data collection policy corresponding to the terminal.

Optionally, in this embodiment of this application, the data reporting information includes at least one of the following: data reporting capability information and data reporting preference information.

In this embodiment of this application, the data reporting capability information is information related to data reporting supported by the terminal; and the data reporting preference information is information related to data reporting expected by the terminal.

In this embodiment of this application, the data reporting information may include information related to data reporting supported by the terminal and/or information related to data reporting expected by the terminal. Therefore, the terminal may report a data reporting capability and/or a preference of the terminal during registration, so that the corresponding data collection policy is determined.

Optionally, in this embodiment of this application, the data reporting capability information may include at least one of the following (1.1) to (1.9):
(1.1) First information, where the first information is used to indicate whether the terminal supports reporting data.
(1.2) First reporting mechanism information, where the first reporting mechanism information is used to indicate whether the terminal supports reporting data by using a first reporting mechanism, and the first reporting mechanism is a reporting mechanism in which a volume of to-be-reported data is greater than or equal to a first preset threshold.

Optionally, in this embodiment of this application, the first reporting mechanism may be a mechanism for reporting a large volume of data.

Optionally, in this embodiment of this application, the first reporting mechanism information may include at least one of the following: data format information of data that needs to be reported, data processing information of data that needs to be reported, and preset data volume threshold information.

In this embodiment of this application, the preset data volume threshold information is used to indicate a minimum data volume that triggers to report data by using the first reporting mechanism.

It may be understood that when the volume of to-be-reported data is greater than or equal to the minimum data volume, the first reporting mechanism needs to be used for data reporting this time.

In this embodiment of this application, the data format information is used to indicate a data format of data that needs to be reported, or is used to indicate a data format after reported data is processed.

In this embodiment of this application, the data processing information is used to indicate processing that needs to be performed in a data collection process or after data collection. For example, the data processing information may include at least one of the following: time window information for data collection, volume information of collected data, condition information triggered by data collection, a processing rule, and the like.

Optionally, in this embodiment of this application, the first reporting mechanism information may further include data type information of a large volume of data, and the data type information of the large volume of data is used to indicate a data type of a large volume of related data that needs to be collected.

Optionally, in this embodiment of this application, the first reporting mechanism information may further include first indication information, and the first indication information is used to indicate whether the first reporting mechanism is supported for reporting data.

In this embodiment of this application, the first reporting mechanism information may include at least one of the preset data volume threshold information, the data format information of data that needs to be reported, and the data processing information of data that needs to be reported, so that the terminal can report data by using the first reporting mechanism based on operations performed for different preset data volume thresholds, different format information, and different processing information, thereby improving data reporting flexibility of the terminal.
(1.3) Second reporting mechanism information, where the second reporting mechanism information is used to indicate whether the terminal supports reporting data by using a mute mechanism (that is, Mute).

Optionally, in this embodiment of this application, the second reporting mechanism information may include at least one of the following: data storage time information and data overflow operation information.

In this embodiment of this application, the mute mechanism allows a data provider to temporarily store data, and then sends the stored data to a task requester (that is, a data consumer) after a data retrieval notification flag (that is, retrieval notification flag) is received.

In this embodiment of this application, the data storage time information is used to indicate a time for storing data.

In this embodiment of this application, the data overflow operation information is used to indicate an operation to be performed when data overflows. For example, the operation may be deleting data based on a data reporting time, or reporting data to another storage network element.

Optionally, in this embodiment of this application, the second reporting mechanism information may further include second indication information, and the second indication information is used to indicate whether the mute mechanism is supported for reporting data.

In this embodiment of this application, the second reporting mechanism information may include at least one of the data storage time information and the data overflow operation information, so that the terminal can support data by using the second reporting mechanism based on different data storage times and operations performed when different data overflows, thereby further improving data reporting flexibility of the terminal.
(1.4) Type information of to-be-reported data, where the type information of the to-be-reported data is used to indicate a data type of to-be-reported data supported by the terminal.

Optionally, in this embodiment of this application, the type information of the to-be-reported data may be type list information of the to-be-reported data, and the type list information of the to-be-reported data may be used to indicate a data type of to-be-reported data listed in a form of a list.

Optionally, in this embodiment of this application, the data type may be a location information data type, a power information data type, or the like.
(1.5) First reporting signature method information, where the first reporting signature method information is used to indicate a reporting signature method supported by the terminal.

Optionally, in this embodiment of this application, the reporting signature method may include at least one of the following: an anonymous method, a semi-anonymous method, and a non-anonymous method.

Optionally, in this embodiment of this application, if the reporting signature method includes the anonymous method, the terminal conceals/deletes an identifier of the terminal in a data reporting process. In this case, only data of the terminal is reported by the terminal.

Optionally, in this embodiment of this application, if the reporting signature method includes the semi-anonymous method, an identifier that is of the terminal and that is corresponding to reported data may be a processed identifier of the terminal or an identifier mapped by a network element based on the identifier of the terminal. In this case, a final network element cannot learn the identifier of the terminal, but an intermediate network element may learn the identifier of the terminal, or two network elements respectively learn partial identifier information of the terminal, and can learn the complete identifier of the terminal only after the two network elements are collaborated.

Optionally, in this embodiment of this application, if the reporting signature method includes the non-anonymous method, the terminal also reports an identifier of the terminal in a data reporting process.

In this embodiment of this application, the reporting signature method may include at least one of the anonymous method, the semi-anonymous method, and the non-anonymous method, so that the terminal can report data in different anonymous methods, thereby improving data reporting flexibility of the terminal.
(1.6) First state information of to-be-reported data, where the first state information of the to-be-reported data is used to indicate a state of to-be-reported data supported by the terminal.

Optionally, in this embodiment of this application, the state of to-be-reported data may include at least one of the following: an raw data state and a data state after data preprocessing.

In this embodiment of this application, the raw data state is used to indicate that data is unprocessed data, and a data format of collected data may be maintained.

Optionally, in this embodiment of this application, the data preprocessing may include at least one of the following a to c:
a. processing a data volume of data from a first data volume to a second data volume, where the first data volume is greater than the second data volume;
b. removing privacy information from data; and
c. processing a data format of data into a target data format.

Optionally, in this embodiment of this application, the foregoing a may be used to reduce a data volume during interaction. For example, the foregoing a may be specifically performing compression processing on to-be-reported data.

Optionally, in this embodiment of this application, the foregoing b may avoid transmission of sensitive information. For example, the foregoing b may be specifically performing processing on sensitive information such as removing an identifier of to-be-reported data, anonymization processing, or differential privacy processing.

Optionally, in this embodiment of this application, the foregoing c may meet a data format requirement of a specific requirement. For example, the foregoing c may be specifically performing data format conversion processing on to-be-reported data, to meet a requirement of a specific model for a data format of input data.

In this embodiment of this application, the data preprocessing may include at least one of the foregoing a to c, so that the terminal can perform different preprocessing on to-be-reported data before data reporting, thereby further improving data reporting flexibility of the terminal.

In this embodiment of this application, the state of to-be-reported data may include at least one of the raw data state and the data state after data preprocessing, so that the terminal can report different types of data, thereby further improving data reporting flexibility of the terminal.
(1.7) First reporting network type information, where the first reporting network information is used to indicate a type of an access network supported when the terminal reports data.

Optionally, in this embodiment of this application, the type of the access network may include non-3GPP (for example, Wi-Fi), 4G LTE, or 5G NR.
(1.8) Reporting channel method information, where the reporting channel method information is used to indicate a reporting channel method supported when the terminal reports data.

Optionally, in this embodiment of this application, the reporting channel method may include at least one of the following: reporting through a User plane (UP), reporting through a Control Plane (CP), and reporting through an Application Function (AF).

In this embodiment of this application, the reporting channel method may include at least one of reporting through a UP, reporting through a CP, and reporting through an AF, so that the terminal can report data in different reporting methods, thereby further improving data reporting flexibility of the terminal.
(1.9) First reporting time information, where the first reporting time information is used to indicate a data reporting time supported by the terminal.

For example, assuming that the first reporting time information indicates 20:00 to 24:00 of each day, the terminal supports reporting data between 20:00 and 24:00 of each day.

In this embodiment of this application, because the data reporting capability information may include at least one of the foregoing (1.1) to (1.9), different data reporting capability information may be used to indicate a data reporting capability of the terminal, thereby improving accuracy of indicating the data reporting capability of the terminal.

Optionally, in this embodiment of this application, the data reporting preference information may include at least one of the following (2.1) to (2.4):
(2.1) second reporting signature method information, where the second reporting signature method information is used to indicate a reporting signature method expected by the terminal;
(2.2) second state of to-be-reported data information, where the second state of to-be-reported data information is used to indicate a state of to-be-reported data expected by the terminal;
(2.3) second reporting network type information, where the second reporting network information is used to indicate a type of an access network expected when the terminal reports data; and
(2.4) second reporting time information, where the second reporting time information is used to indicate a data reporting time expected by the terminal.

For specific descriptions of this embodiment of this application, refer to the related descriptions of the foregoing embodiment. To avoid repetition, details are not described herein again.

Optionally, in this embodiment of this application, the data reporting preference information may further include third indication information, and the third indication information is used to indicate whether the terminal expects to report (or share) data.

Optionally, in this embodiment of this application, the third indication information may include at least one of the following:
first sharing information, where the first sharing information is used to indicate that the terminal expects to share data with a core network (for example, a network element in the core network);
second sharing information, where the second sharing information is used to indicate that the terminal expects to share data with an external (for example, a network element that is not in a core network); and
third sharing information, where the third sharing information is used to indicate a group feature/information of a plurality of terminals in a statistical area, and the terminal expects to share data when there is only one terminal or a small quantity of terminals in the area.

In this embodiment of this application, because the data reporting preference information may include at least one of the foregoing (2.1) to (2.4), different data reporting preference information may be used to indicate a data reporting preference of the terminal, thereby improving accuracy of indicating the data reporting preference of the terminal.

Optionally, in this embodiment of this application, the registration request message may further include identifier information of the terminal, so that a network element learns that the registration request message is sent by the terminal.

Optionally, in this embodiment of this application, the data collection policy may include at least one of the following (3.1) to (3.6):
(3.1) a data state of data;
(3.2) a signature method of data;
(3.3) a type of a network accessed by the terminal during data reporting;
(3.4) a reporting channel method supported by the terminal during data reporting;
(3.5) whether a data collection mechanism includes a first collection mechanism, where the first collection mechanism is a collection mechanism in which a volume of to-be-collected data is greater than or equal to a second preset threshold; and
(3.6) whether a data collection mechanism includes a mute mechanism.

For specific descriptions of this embodiment of this application, refer to the related descriptions of the foregoing embodiment. To avoid repetition, details are not described herein again.

In this embodiment of this application, because the data collection policy may include at least one of the foregoing (3.1) to (3.6), different data collection policies may be used to instruct a terminal to collect corresponding data, thereby improving data collection flexibility.

In the information reporting method provided in this embodiment of this application, the terminal may send the registration request message including the data reporting information of the terminal, to request registration. Therefore, the terminal may complete reporting of the data reporting information of the terminal during registration, so that the data reporting information of the terminal can be reported.

Optionally, in this embodiment of this application, after the foregoing step 301, the information reporting method provided in this embodiment of this application may further include the following step 302.

Step 302: The terminal receives a registration response message from a first network element.

In this embodiment of this application, the registration response message includes the data collection policy.

In this embodiment of this application, the first network element is a network element responsible for terminal registration.

Optionally, in this embodiment of this application, the first network element may be an AMF.

In this embodiment of this application, because the terminal may receive the registration response message including the data collection policy, the corresponding data collection policy may be obtained in a registration process, so as to accurately collect data.

An embodiment of this application provides an information reporting method. FIG. 4 is a flowchart of an information reporting method according to an embodiment of this application. As shown in FIG. 4, the information reporting method provided in this embodiment of this application may include the following steps 401 to 403.

Step 401: A first network element receives a registration request message from a terminal.

In this embodiment of this application, the registration request message includes data reporting information of the terminal, and the data reporting information is used to determine a data collection policy corresponding to the terminal.

In this embodiment of this application, the first network element is a network element responsible for terminal registration.

Optionally, in this embodiment of this application, the terminal may send the registration request message to a base station, and the base station sends the registration request message to the first network element after selecting the first network element, so that the first network element can receive the registration request message.

Optionally, in this embodiment of this application, the data reporting information includes at least one of the following: data reporting capability information and data reporting preference information.

In this embodiment of this application, the data reporting capability information is information related to data reporting supported by the terminal; and the data reporting preference information is information related to data reporting expected by the terminal.

Optionally, in this embodiment of this application, the data reporting capability information may include at least one of the following (4.1) to (4.9):
(4.1) first information, where the first information is used to indicate whether the terminal supports reporting data;
(4.2) first reporting mechanism information, where the first reporting mechanism information is used to indicate whether the terminal supports reporting data by using a first reporting mechanism, and the first reporting mechanism is a reporting mechanism in which a volume of to-be-reported data is greater than or equal to a first preset threshold;
(4.3) second reporting mechanism information, where the second reporting mechanism information is used to indicate whether the terminal supports reporting data by using a mute mechanism;
(4.4) type information of to-be-reported data, where the type information of the to-be-reported data is used to indicate a data type of to-be-reported data supported by the terminal;
(4.5) first reporting signature method information, where the first reporting signature method information is used to indicate a reporting signature method supported by the terminal;
(4.6) first state information of to-be-reported data, where the first state information of the to-be-reported data is used to indicate a state of to-be-reported data supported by the terminal;
(4.7) first reporting network type information, where the first reporting network information is used to indicate a type of an access network supported when the terminal reports data;
(4.8) reporting channel method information, where the reporting channel method information is used to indicate a reporting channel method supported when the terminal reports data; and
(4.9) first reporting time information, where the first reporting time information is used to indicate a data reporting time supported by the terminal.

Optionally, in this embodiment of this application, the data reporting preference information may include at least one of the following (5.1) to (5.4):
(5.1) second reporting signature method information, where the second reporting signature method information is used to indicate a reporting signature method expected by the terminal;
(5.2) second state of to-be-reported data information, where the second state of to-be-reported data information is used to indicate a state of to-be-reported data expected by the terminal;
(5.3) second reporting network type information, where the second reporting network information is used to indicate a type of an access network expected when the terminal reports data; and
(5.4) second reporting time information, where the second reporting time information is used to indicate a data reporting time expected by the terminal.

Optionally, in this embodiment of this application, the data collection policy may include at least one of the following (6.1) to (6.6):
(6.1) a data state of data;
(6.2) a signature method of data;
(6.3) a type of a network accessed by the terminal during data reporting;
(6.4) a reporting channel method supported by the terminal during data reporting;
(6.5) whether a data collection mechanism includes a first collection mechanism, where the first collection mechanism is a collection mechanism in which a volume of to-be-collected data is greater than or equal to a second preset threshold; and
(6.6) whether a data collection mechanism includes a mute mechanism.

Step 402: The first network element sends a first message to a second network element, and sends a second message to a third network element.

In this embodiment of this application, the first message includes the data reporting information.

In this embodiment of this application, the second message is used to request the third network element to determine the data collection policy.

In this embodiment of this application, the second network element is a network element responsible for data management.

In this embodiment of this application, the third network element is a network element responsible for determining a policy.

Optionally, in this embodiment of this application, the second network element may be a UDM.

Optionally, in this embodiment of this application, the third network element may be a PCF.

Optionally, in this embodiment of this application, the first message may be carried in Nudm_UECM_Registration signaling.

Optionally, in this embodiment of this application, the second message may include the data reporting information.

In this embodiment of this application, because the second message may include the data reporting information, the first network element may directly send the data reporting information to the third network element, thereby simplifying a process of obtaining the data reporting information by the third network element.

Optionally, in this embodiment of this application, before sending the second message to the third network element, the first network element may first determine the third network element based on context information of the terminal. The third network element may be a network element that is previously associated or a network element that is associated for the first time.

Optionally, in this embodiment of this application, the first network element sends the first message including the data reporting information to the second network element, so that the second network element can store the data reporting information.

Step 403: The first network element sends a registration response message to the terminal.

In this embodiment of this application, the registration response message includes the determined data collection policy.

In this embodiment of this application, the registration response message is used to notify the foregoing terminal that registration is completed.

In the information reporting method provided in this embodiment of this application, the first network element may receive the registration request message that is sent by the terminal and that includes the data reporting information of the terminal, send the data reporting information to the second network element, send the second message to the third network element to request to determine the data collection policy corresponding to the terminal, and send the registration response message including the data collection policy to the terminal. That is, the network element may receive the data reporting information of the terminal in a registration process of the terminal, so that the data reporting information of the terminal can be reported.

For specific descriptions in this embodiment of this application and technical effects that can be achieved by each technical feature, refer to the related descriptions of the foregoing method embodiments on the terminal side. To avoid repetition, details are not described herein again.

An embodiment of this application provides an information reporting method. FIG. 5 is a flowchart of an information reporting method according to an embodiment of this application. As shown in FIG. 5, the information reporting method provided in this embodiment of this application may include the following step 501 and step 502.

Step 501: A third network element receives a second message from a first network element.

In this embodiment of this application, the second message is used to request the third network element to determine a data collection policy corresponding to a terminal.

In this embodiment of this application, the first network element is a network element responsible for terminal registration.

In this embodiment of this application, the third network element is a network element responsible for determining a policy.

Optionally, in this embodiment of this application, the data collection policy may include at least one of the following (7.1) to (7.6):
(7.1) a data state of data;
(7.2) a signature method of data;
(7.3) a type of a network accessed by the terminal during data reporting;
(7.4) a reporting channel method supported by the terminal during data reporting;
(7.5) whether a data collection mechanism includes a first collection mechanism, where the first collection mechanism is a collection mechanism in which a volume of to-be-collected data is greater than or equal to a second preset threshold; and
(7.6) whether a data collection mechanism includes a mute mechanism.

Step 502: The third network element determines the data collection policy based on the obtained data reporting information of the terminal.

In this embodiment of this application, the data reporting information is used to determine the data collection policy.

Optionally, in this embodiment of this application, the data reporting information includes at least one of the following: data reporting capability information and data reporting preference information.

In this embodiment of this application, the data reporting capability information is information related to data reporting supported by the terminal; and the data reporting preference information is information related to data reporting expected by the terminal.

Optionally, in this embodiment of this application, the data reporting capability information may include at least one of the following (8.1) to (8.9):
(8.1) first information, where the first information is used to indicate whether the terminal supports reporting data;
(8.2) first reporting mechanism information, where the first reporting mechanism information is used to indicate whether the terminal supports reporting data by using a first reporting mechanism, and the first reporting mechanism is a reporting mechanism in which a volume of to-be-reported data is greater than or equal to a first preset threshold;
(8.3) second reporting mechanism information, where the second reporting mechanism information is used to indicate whether the terminal supports reporting data by using a mute mechanism;
(8.4) type information of to-be-reported data, where the type information of the to-be-reported data is used to indicate a data type of to-be-reported data supported by the terminal;
(8.5) first reporting signature method information, where the first reporting signature method information is used to indicate a reporting signature method supported by the terminal;
(8.6) first state information of to-be-reported data, where the first state information of the to-be-reported data is used to indicate a state of to-be-reported data supported by the terminal;
(8.7) first reporting network type information, where the first reporting network information is used to indicate a type of an access network supported when the terminal reports data;
(8.8) reporting channel method information, where the reporting channel method information is used to indicate a reporting channel method supported when the terminal reports data; and
(8.9) first reporting time information, where the first reporting time information is used to indicate a data reporting time supported by the terminal.

Optionally, in this embodiment of this application, the data reporting preference information may include at least one of the following (9.1) to (9.4):
(9.1) second reporting signature method information, where the second reporting signature method information is used to indicate a reporting signature method expected by the terminal;
(9.2) second state of to-be-reported data information, where the second state of to-be-reported data information is used to indicate a state of to-be-reported data expected by the terminal;
(9.3) second reporting network type information, where the second reporting network information is used to indicate a type of an access network expected when the terminal reports data; and
(9.4) second reporting time information, where the second reporting time information is used to indicate a data reporting time expected by the terminal.

Optionally, in this embodiment of this application, the data reporting information may be obtained from at least one of the following: the second message and a second network element.

In this embodiment of this application, the second network element is a network element responsible for data management.

Optionally, in this embodiment of this application, the third network element may directly obtain the data reporting information by using the received second message.

Optionally, in this embodiment of this application, after the third network element receives the second message, if the second message does not include the data reporting information, the third network element may send a data obtaining request message to the second network element, to request to obtain the data reporting information from data stored in the second network element.

Optionally, in this embodiment of this application, the data obtaining request message may be carried in Nudm_SDM_Get/Nudm_SDM_Subscribe signaling.

In this embodiment of this application, because the data reporting information may be obtained from the second message and/or the second network element, flexibility of obtaining the data reporting information by the third network element can be improved.

The following exemplarily describes a specific method for determining the data collection policy by the third network element.

For example, if the data reporting information obtained by the third network element includes the first reporting network type information, and the first reporting network information indicates that the type of the access network supported when the terminal reports data is type A, the third network element may determine the data collection policy based on the data reporting information, and the data collection policy includes: the type of the network accessed by the terminal during data reporting is type A.

For another example, it is assumed that the data reporting information obtained by the third network element includes the first reporting signature method information and the second reporting signature method information, and the first reporting signature method information indicates that the reporting signature method supported by the terminal is the anonymous method, and the second reporting signature method information indicates that the reporting signature method expected by the terminal is also the anonymous method. Therefore, the third network element may determine the data collection policy based on the data reporting information, and the data collection policy includes: the signature method of the data is the anonymous method.

It may be learned that the second network element may determine, based on data indicated by the data reporting capability information and/or data indicated by the data reporting preference information, and a degree of matching with to-be-collected data indicated by the data collection information, whether to send the foregoing data collection request message to a target terminal.

It may be learned that the third network element may determine the corresponding data collection policy based on content indicated by the data reporting information, so that the determined data collection policy meets a data reporting capability and/or a preference of the terminal.

In the information reporting method provided in this embodiment of this application, after receiving the second message that is sent by the first network element and that is used to request to determine the data collection policy corresponding to the terminal, the third network element may determine the data collection policy based on the obtained data reporting information of the terminal. That is, when determining the data collection policy corresponding to the terminal, the third network element may first obtain the data reporting information of the terminal, so that the data reporting information of the terminal can be reported.

For specific descriptions in this embodiment of this application and technical effects that can be achieved by each technical feature, refer to the related descriptions of the foregoing method embodiments on the terminal side and the first network element side. To avoid repetition, details are not described herein again.

The following exemplarily describes the data collection method provided in the embodiments of this application with reference to the accompanying drawings.

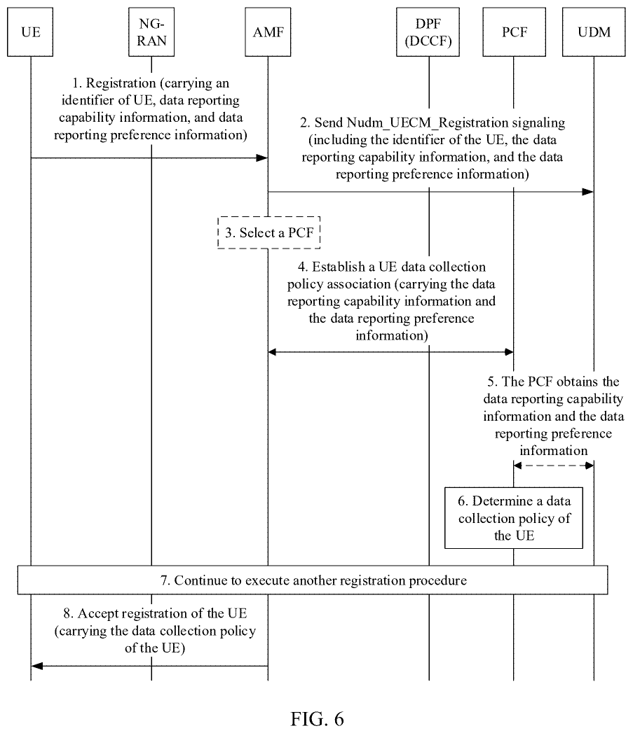

For example, as shown in FIG. 6, if it is required to obtain data reporting information of UE (that is, the foregoing terminal), the UE may report the data reporting information of the UE in a registration process through the following steps:
1. In a process of registering with an AMF (that is, the first network element) by the UE, identifier information of the UE and data reporting information of the UE (including data reporting capability information and data reporting preference information) are carried.
2. The AMF sends Nudm_UECM_Registration signaling to a UDM (that is, the second network element), where the signaling includes the identifier information of the UE, the data reporting capability information, and the data reporting preference information, so that the UDM stores obtained data information.
3. The AMF selects a proper PCF (that is, the third network element) based on the identifier information of the UE.
4. The AMF establishes a UE data collection policy association with the selected PCF, where the data reporting capability information and the data reporting preference information are carried.
5. The PCF interacts with the UDM to obtain the data reporting capability information and the data reporting preference information.
6. The PCF determines a data collection policy of the UE.
7. Continue to execute another registration process. For example, the AMF sends a request for modifying a context to a network element such as a non-3GPP network element.
8. The AMF accepts registration of the UE, and notifies the UE that the registration is completed, where the data collection policy of the UE determined by the PCF is carried, to notify the UE of a data collection manner that is initiated by a network side and that may be encountered by the UE in the future.

In this way, in the registration process of the UE, the UE may report the data reporting information of the UE, and the PCF in the network may determine the data collection policy of the UE, so that the network can collect more information about the UE while complying with the preference of the UE.

The information reporting method provided in the embodiments of this application may be executed by an information reporting apparatus. In the embodiments of this application, an example in which the information reporting apparatus executes the information reporting method is used to describe the information reporting apparatus provided in the embodiments of this application.

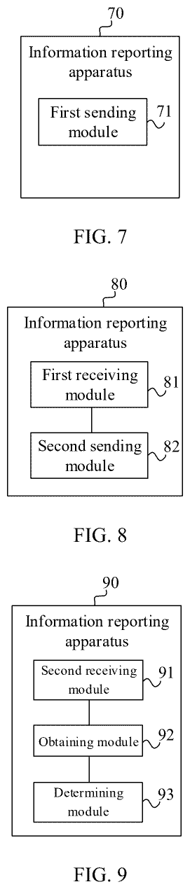

With reference to FIG. 7, an embodiment of this application provides an information reporting apparatus 70. The information reporting apparatus 70 may include a first sending module 71. The first sending module 71 may be configured to send a registration request message to request registration. The registration request message includes data reporting information of the information reporting apparatus 70, and the data reporting information is used to determine a data collection policy corresponding to the information reporting apparatus 70.

In a possible implementation, the data reporting information may include at least one of the following: data reporting capability information and data reporting preference information.

In a possible implementation, the data reporting capability information may include at least one of the following: first information, where the first information is used to indicate whether the information reporting apparatus 70 supports reporting data; first reporting mechanism information, where the first reporting mechanism information is used to indicate whether the information reporting apparatus 70 supports reporting data by using a first reporting mechanism, and the first reporting mechanism is a reporting mechanism in which a volume of to-be-reported data is greater than or equal to a first preset threshold; second reporting mechanism information, where the second reporting mechanism information is used to indicate whether the information reporting apparatus 70 supports reporting data by using a mute mechanism; type information of to-be-reported data, where the type information of the to-be-reported data is used to indicate a data type of to-be-reported data supported by the information reporting apparatus 70; first reporting signature method information, where the first reporting signature method information is used to indicate a reporting signature method supported by the information reporting apparatus 70; first state information of to-be-reported data, where the first state information of the to-be-reported data is used to indicate a state of to-be-reported data supported by the information reporting apparatus 70; first reporting network type information, where the first reporting network information is used to indicate a type of an access network supported when the information reporting apparatus 70 reports data; reporting channel method information, where the reporting channel method information is used to indicate a reporting channel method supported when the information reporting apparatus 70 reports data; and first reporting time information, where the first reporting time information is used to indicate a data reporting time supported by the information reporting apparatus 70.

In a possible implementation, the first reporting mechanism information may include at least one of the following: data format information of data that needs to be reported, data processing information of data that needs to be reported, and preset data volume threshold information. The preset data volume threshold information is used to indicate a minimum data volume that triggers to report data by using the first reporting mechanism.

In a possible implementation, the second reporting mechanism information may include at least one of the following: data storage time information and data overflow operation information.

In a possible implementation, the reporting signature method may include at least one of the following: an anonymous method, a semi-anonymous method, and a non-anonymous method.

In a possible implementation, the state of to-be-reported data may include at least one of the following: an raw data state and a data state after data preprocessing.

In a possible implementation, the data preprocessing may include at least one of the following: processing a data volume of data from a first data volume to a second data volume, where the first data volume is greater than the second data volume; removing privacy information from data; and processing a data format of data into a target data format.

In a possible implementation, the reporting channel method may include at least one of the following: reporting through a user plane UP, reporting through a control plane CP, and reporting through an application function AF.

In a possible implementation, the data reporting preference information may include at least one of the following: second reporting signature method information, where the second reporting signature method information is used to indicate a reporting signature method expected by the information reporting apparatus 70; second state of to-be-reported data information, where the second state of to-be-reported data information is used to indicate a state of to-be-reported data expected by the information reporting apparatus 70; second reporting network type information, where the second reporting network information is used to indicate a type of an access network expected when the information reporting apparatus 70 reports data; and second reporting time information, where the second reporting time information is used to indicate a data reporting time expected by the information reporting apparatus 70.

In a possible implementation, the data collection policy may include at least one of the following: a data state of data; a signature method of data; a type of a network accessed by the terminal during data reporting; a reporting channel method supported by the terminal during data reporting; whether a data collection mechanism includes a first collection mechanism, where the first collection mechanism is a collection mechanism in which a volume of to-be-collected data is greater than or equal to a second preset threshold; and whether a data collection mechanism includes a mute mechanism.

In a possible implementation, the registration request message may further include identifier information of the terminal.

In a possible implementation, the information reporting apparatus 70 may further include a receiving module. The receiving module may be configured to receive a registration response message from a first network element after the first sending module 71 sends the registration request message. The registration response message includes the data collection policy.

In the information reporting apparatus provided in this embodiment of this application, the information reporting apparatus may send the registration request message including the data reporting information of the information reporting apparatus, to request registration. Therefore, the information reporting apparatus may complete reporting of the data reporting information of the information reporting apparatus during registration, so that the data reporting information can be reported.

The information reporting apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The information reporting apparatus provided in this embodiment of this application can implement the processes implemented in the foregoing method embodiment on the terminal side, and achieve a same technical effect. To avoid repetition, details are not described herein again.

With reference to FIG. 8, an embodiment of this application provides an information reporting apparatus 80. The information reporting apparatus 80 may include a first receiving module 81 and a second sending module 82. The first receiving module 81 may be configured to receive a registration request message from a terminal, where the registration request message includes data reporting information of the terminal, and the data reporting information is used to determine a data collection policy corresponding to the terminal. The second sending module 82 may be configured to: send a first message to a second network element, and send a second message to a third network element, where the first message includes the data reporting information, and the second message is used to request the third network element to determine the data collection policy. The second sending module 82 may be further configured to send a registration response message to the terminal, where the registration response message includes the determined data collection policy.

In a possible implementation, the data reporting information may include at least one of the following: data reporting capability information and data reporting preference information.

In a possible implementation, the data reporting capability information may include at least one of the following: first information, where the first information is used to indicate whether the terminal supports reporting data; first reporting mechanism information, where the first reporting mechanism information is used to indicate whether the terminal supports reporting data by using a first reporting mechanism, and the first reporting mechanism is a reporting mechanism in which a volume of to-be-reported data is greater than or equal to a first preset threshold; second reporting mechanism information, where the second reporting mechanism information is used to indicate whether the terminal supports reporting data by using a mute mechanism; type information of to-be-reported data, where the type information of the to-be-reported data is used to indicate a data type of to-be-reported data supported by the terminal; first reporting signature method information, where the first reporting signature method information is used to indicate a reporting signature method supported by the terminal; first state information of to-be-reported data, where the first state information of the to-be-reported data is used to indicate a state of to-be-reported data supported by the terminal; first reporting network type information, where the first reporting network information is used to indicate a type of an access network supported when the terminal reports data; reporting channel method information, where the reporting channel method information is used to indicate a reporting channel method supported when the terminal reports data; and first reporting time information, where the first reporting time information is used to indicate a data reporting time supported by the terminal.

In a possible implementation, the data reporting preference information may include at least one of the following: second reporting signature method information, where the second reporting signature method information is used to indicate a reporting signature method expected by the terminal; second state of to-be-reported data information, where the second state of to-be-reported data information is used to indicate a state of to-be-reported data expected by the terminal; second reporting network type information, where the second reporting network information is used to indicate a type of an access network expected when the terminal reports data; and second reporting time information, where the second reporting time information is used to indicate a data reporting time expected by the terminal.

In a possible implementation, the data collection policy may include at least one of the following: a data state of data; a signature method of data; a type of a network accessed by the terminal during data reporting; a reporting channel method supported by the terminal during data reporting; whether a data collection mechanism includes a first collection mechanism, where the first collection mechanism is a collection mechanism in which a volume of to-be-collected data is greater than or equal to a second preset threshold; and whether a data collection mechanism includes a mute mechanism.

In a possible implementation, the second message may include the data reporting information.

In the information reporting apparatus provided in this embodiment of this application, the information reporting apparatus may receive the registration request message that is sent by the terminal and that includes the data reporting information of the terminal, send the data reporting information to the second network element, send the second message to the third network element to request to determine the data collection policy corresponding to the terminal, and send the registration response message including the data collection policy to the terminal. That is, the network element may receive the data reporting information of the terminal in a registration process of the terminal, so that the data reporting information of the terminal can be reported.

The information reporting apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The information reporting apparatus provided in this embodiment of this application can implement the processes implemented in the foregoing method embodiment on the first network element side, and achieve a same technical effect. To avoid repetition, details are not described herein again.

With reference to FIG. 9, an embodiment of this application provides an information reporting apparatus 90. The information reporting apparatus 90 may include a second receiving module 91, an obtaining module 92, and a determining module 93. The second receiving module 91 may be configured to receive a second message from a first network element, where the second message is used to request the information reporting apparatus 90 to determine a data collection policy corresponding to a terminal. The determining module 93 may be configured to determine the data collection policy based on the data reporting information of the terminal obtained by the obtaining module 92, where the data reporting information is used to determine the data collection policy.

In a possible implementation, the data reporting information may include at least one of the following: data reporting capability information and data reporting preference information.

In a possible implementation, the data reporting capability information may include at least one of the following: first information, where the first information is used to indicate whether the terminal supports reporting data; first reporting mechanism information, where the first reporting mechanism information is used to indicate whether the terminal supports reporting data by using a first reporting mechanism, and the first reporting mechanism is a reporting mechanism in which a volume of to-be-reported data is greater than or equal to a first preset threshold; second reporting mechanism information, where the second reporting mechanism information is used to indicate whether the terminal supports reporting data by using a mute mechanism; type information of to-be-reported data, where the type information of the to-be-reported data is used to indicate a data type of to-be-reported data supported by the terminal; first reporting signature method information, where the first reporting signature method information is used to indicate a reporting signature method supported by the terminal; first state information of to-be-reported data, where the first state information of the to-be-reported data is used to indicate a state of to-be-reported data supported by the terminal; first reporting network type information, where the first reporting network information is used to indicate a type of an access network supported when the terminal reports data; reporting channel method information, where the reporting channel method information is used to indicate a reporting channel method supported when the terminal reports data; and first reporting time information, where the first reporting time information is used to indicate a data reporting time supported by the terminal.

In a possible implementation, the data reporting preference information may include at least one of the following: second reporting signature method information, where the second reporting signature method information is used to indicate a reporting signature method expected by the terminal; second state of to-be-reported data information, where the second state of to-be-reported data information is used to indicate a state of to-be-reported data expected by the terminal; second reporting network type information, where the second reporting network information is used to indicate a type of an access network expected when the terminal reports data; and second reporting time information, where the second reporting time information is used to indicate a data reporting time expected by the terminal.

In a possible implementation, the data collection policy may include at least one of the following: a data state of data; a signature method of data; a type of a network accessed by the terminal during data reporting; a reporting channel method supported by the terminal during data reporting; whether a data collection mechanism includes a first collection mechanism, where the first collection mechanism is a collection mechanism in which a volume of to-be-collected data is greater than or equal to a second preset threshold; and whether a data collection mechanism includes a mute mechanism.

In a possible implementation, the data reporting information may be obtained from at least one of the following: the second message and a second network element. The second network element is a network element responsible for data management.

In the information reporting apparatus provided in this embodiment of this application, after receiving the second message that is sent by the first network element and that is used to request to determine the data collection policy corresponding to the terminal, the information reporting apparatus may determine the data collection policy based on the obtained data reporting information of the terminal. That is, when determining the data collection policy corresponding to the terminal, the information reporting apparatus may first obtain the data reporting information of the terminal, so that the data reporting information of the terminal can be reported.

The information reporting apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The information reporting apparatus provided in this embodiment of this application can implement the processes implemented in the foregoing method embodiment on the third network element side, and achieve a same technical effect. To avoid repetition, details are not described herein again.

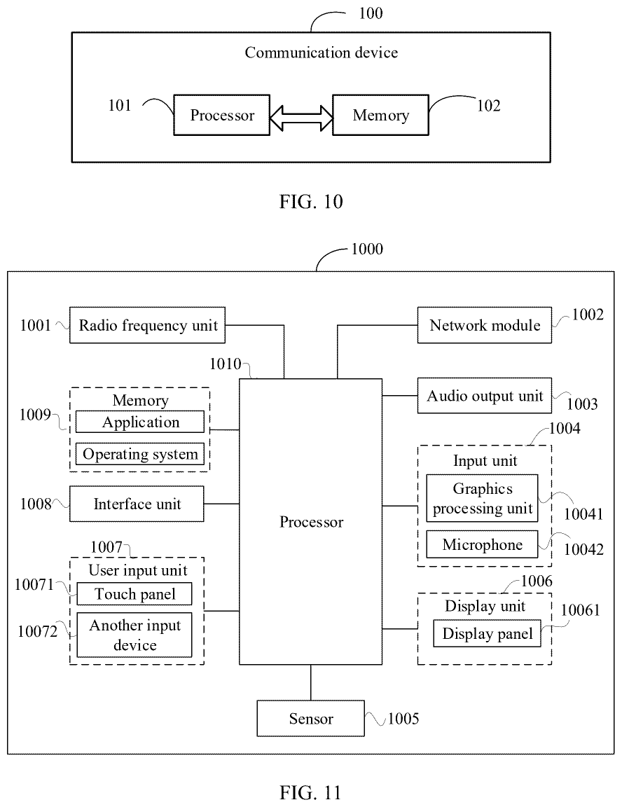

Optionally, as shown in FIG. 10, an embodiment of this application further provides a communication device 100, including a processor 101 and a memory 102. The memory 102 stores a program or an instruction that can be run on the processor 101. For example, when the communication device 100 is a terminal, the program or the instruction is executed by the processor 101 to implement the steps of the foregoing method embodiment on the terminal side, and a same technical effect can be achieved. When the communication device 100 is a network side device, the program or the instruction is executed by the processor 101 to implement the steps of the foregoing method embodiment on the first network element side or the third network element side, and a same technical effect can be achieved. To avoid repetition, details are not described herein again.

An embodiment of this application further provides a terminal, including a processor and a communication interface. The communication interface is configured to send a registration request message to request registration, where the registration request message includes data reporting information of the terminal, and the data reporting information is used to determine a data collection policy corresponding to the terminal. This terminal embodiment corresponds to the foregoing method embodiment on the terminal side, each implementation process and implementation of the foregoing method embodiment can be applied to this terminal embodiment, and a same technical effect can be achieved. Specifically, FIG. 11 is a schematic structural diagram of hardware of a terminal according to an embodiment of this application.

The terminal 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include the power supply (for example, a battery) that supplies power to each component. The power supply may be logically connected to the processor 1010 by using a power supply management system, so as to manage functions such as charging, discharging, and power consumption by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that, in this embodiment of this application, the input unit 1004 may include a Graphics Processing Unit (GPU) 10041 and a microphone 10042, and the graphics processing unit 10041 processes image data of a still image or a video that is obtained by an image capturing apparatus (for example, a camera) in a video capturing mode or an image capturing mode. The display unit 1006 may include a display panel 10061. The display panel 10061 may be configured in a form such as a liquid crystal display or an organic light-emitting diode. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Usually, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The nonvolatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1009 in this embodiment of this application includes but is not limited to these memories and a memory of any other proper type.

The processor 1010 may include one or more processing units. Optionally, an application processor and a modem processor are integrated into the processor 1010. The application processor mainly processes an operating system, a user interface, an application, and the like. The modem processor mainly processes a wireless communication signal, for example, a baseband processor. It can be understood that, alternatively, the modem processor may not be integrated into the processor 1010.

The radio frequency unit 1001 may be configured to send a registration request message to request registration. The registration request message includes data reporting information of the terminal 1000, and the data reporting information is used to determine a data collection policy corresponding to the terminal 1000.

In a possible implementation, the data reporting information may include at least one of the following: data reporting capability information and data reporting preference information.

In a possible implementation, the data reporting capability information may include at least one of the following: first information, where the first information is used to indicate whether the terminal 1000 supports reporting data; first reporting mechanism information, where the first reporting mechanism information is used to indicate whether the terminal 1000 supports reporting data by using a first reporting mechanism, and the first reporting mechanism is a reporting mechanism in which a volume of to-be-reported data is greater than or equal to a first preset threshold; second reporting mechanism information, where the second reporting mechanism information is used to indicate whether the terminal 1000 supports reporting data by using a mute mechanism; type information of to-be-reported data, where the type information of the to-be-reported data is used to indicate a data type of to-be-reported data supported by the terminal 1000; first reporting signature method information, where the first reporting signature method information is used to indicate a reporting signature method supported by the terminal 1000; first state information of to-be-reported data, where the first state information of the to-be-reported data is used to indicate a state of to-be-reported data supported by the terminal 1000; first reporting network type information, where the first reporting network information is used to indicate a type of an access network supported when the terminal 1000 reports data; reporting channel method information, where the reporting channel method information is used to indicate a reporting channel method supported when the terminal 1000 reports data; and first reporting time information, where the first reporting time information is used to indicate a data reporting time supported by the terminal 1000.

In a possible implementation, the first reporting mechanism information may include at least one of the following: data format information of data that needs to be reported, data processing information of data that needs to be reported, and preset data volume threshold information. The preset data volume threshold information is used to indicate a minimum data volume that triggers to report data by using the first reporting mechanism.

In a possible implementation, the second reporting mechanism information may include at least one of the following: data storage time information and data overflow operation information.

In a possible implementation, the reporting signature method may include at least one of the following: an anonymous method, a semi-anonymous method, and a non-anonymous method.

In a possible implementation, the state of to-be-reported data may include at least one of the following: an raw and a data state after data preprocessing.

In a possible implementation, the data preprocessing may include at least one of the following: processing a data volume of data from a first data volume to a second data volume, where the first data volume is greater than the second data volume; removing privacy information from data; and processing a data format of data into a target data format.

In a possible implementation, the reporting channel method may include at least one of the following: reporting through a user plane UP, reporting through a control plane CP, and reporting through an application function AF.

In a possible implementation, the data reporting preference information may include at least one of the following: second reporting signature method information, where the second reporting signature method information is used to indicate a reporting signature method expected by the terminal 1000; second state of to-be-reported data information, where the second state of to-be-reported data information is used to indicate a state of to-be-reported data expected by the terminal 1000; second reporting network type information, where the second reporting network information is used to indicate a type of an access network expected when the terminal 1000 reports data; and second reporting time information, where the second reporting time information is used to indicate a data reporting time expected by the terminal 1000.

In a possible implementation, the data collection policy may include at least one of the following: a data state of data; a signature method of data; a type of a network accessed by the terminal during data reporting; a reporting channel method supported by the terminal during data reporting; whether a data collection mechanism includes a first collection mechanism, where the first collection mechanism is a collection mechanism in which a volume of to-be-collected data is greater than or equal to a second preset threshold; and whether a data collection mechanism includes a mute mechanism.

In a possible implementation, the registration request message may further include identifier information of the terminal.

In a possible implementation, the radio frequency unit 1001 may be further configured to receive a registration response message from a first network element after sending the registration request message. The registration response message includes the data collection policy.

In the terminal provided in this embodiment of this application, the terminal may send the registration request message including the data reporting information of the terminal, to request registration. Therefore, the terminal may complete reporting of the data reporting information of the terminal during registration, so that the data reporting information of the terminal can be reported.

The terminal provided in this embodiment of this application can implement the processes implemented by the terminal in the foregoing method embodiment, and achieve a same technical effect. To avoid repetition, details are not described herein again.

An embodiment of this application further provides a network side device, including a processor and a communication interface. The communication interface is configured to receive a registration request message from a terminal, where the registration request message includes data reporting information of the terminal, and the data reporting information is used to determine a data collection policy corresponding to the terminal; send a first message to a second network element, and send a second message to a third network element, where the first message includes the data reporting information, and the second message is used to request the third network element to determine the data collection policy; and send a registration response message to the terminal, where the registration response message includes the determined data collection policy. Alternatively, the communication interface is configured to receive a second message from a first network element, where the second message is used to request the network side device to determine a data collection policy corresponding to a terminal; and the processor is configured to determine the data collection policy based on the obtained data reporting information of the terminal, where the data reporting information is used to determine the data collection policy. This network side device embodiment corresponds to the foregoing method embodiment on the first network element side or third network element side, each implementation process and implementation of the foregoing method embodiment can be applied to this network side device embodiment, and a same technical effect can be achieved.

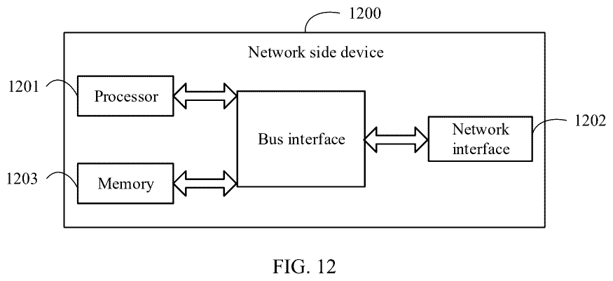

Specifically, an embodiment of this application further provides a network side device. As shown in FIG. 12, a network side device 1200 includes a processor 1201, a network interface 1202, and a memory 1203. The network interface 1202 is, for example, a common public radio interface (CPRI).

Specifically, the network side device 1200 in this embodiment of this application further includes an instruction or a program that is stored in the memory 1203 and that can be run on the processor 1201. The processor 1201 invokes the instruction or the program in the memory 1203 to execute the method executed by the modules shown in FIG. 7, or the method executed by the modules shown in FIG. 8, and a same technical effect is achieved. To avoid repetition, details are not described herein again.

In an example in which the network side device 1200 is the foregoing first network element, the network interface 1202 may be configured to: receive a registration request message from a terminal, where the registration request message includes data reporting information of the terminal, and the data reporting information is used to determine a data collection policy corresponding to the terminal; send a first message to a second network element, and send a second message to a third network element, where the first message includes the data reporting information, and the second message is used to request the third network element to determine the data collection policy; and send a registration response message to the terminal, where the registration response message includes the determined data collection policy.

In a possible implementation, the data reporting information may include at least one of the following: data reporting capability information and data reporting preference information.

In a possible implementation, the data reporting capability information may include at least one of the following: first information, where the first information is used to indicate whether the terminal supports reporting data; first reporting mechanism information, where the first reporting mechanism information is used to indicate whether the terminal supports reporting data by using a first reporting mechanism, and the first reporting mechanism is a reporting mechanism in which a volume of to-be-reported data is greater than or equal to a first preset threshold; second reporting mechanism information, where the second reporting mechanism information is used to indicate whether the terminal supports reporting data by using a mute mechanism; type information of to-be-reported data, where the type information of the to-be-reported data is used to indicate a data type of to-be-reported data supported by the terminal; first reporting signature method information, where the first reporting signature method information is used to indicate a reporting signature method supported by the terminal; first state information of to-be-reported data, where the first state information of the to-be-reported data is used to indicate a state of to-be-reported data supported by the terminal; first reporting network type information, where the first reporting network information is used to indicate a type of an access network supported when the terminal reports data; reporting channel method information, where the reporting channel method information is used to indicate a reporting channel method supported when the terminal reports data; and first reporting time information, where the first reporting time information is used to indicate a data reporting time supported by the terminal.

In a possible implementation, the data reporting preference information may include at least one of the following: second reporting signature method information, where the second reporting signature method information is used to indicate a reporting signature method expected by the terminal; second state of to-be-reported data information, where the second state of to-be-reported data information is used to indicate a state of to-be-reported data expected by the terminal; second reporting network type information, where the second reporting network information is used to indicate a type of an access network expected when the terminal reports data; and second reporting time information, where the second reporting time information is used to indicate a data reporting time expected by the terminal.

In a possible implementation, the data collection policy may include at least one of the following: a data state of data; a signature method of data; a type of a network accessed by the terminal during data reporting; a reporting channel method supported by the terminal during data reporting; whether a data collection mechanism includes a first collection mechanism, where the first collection mechanism is a collection mechanism in which a volume of to-be-collected data is greater than or equal to a second preset threshold; and whether a data collection mechanism includes a mute mechanism.

In a possible implementation, the second message may include the data reporting information.

In the network side device provided in this embodiment of this application, the network side device may receive the registration request message that is sent by the terminal and that includes the data reporting information of the terminal, send the data reporting information to the second network element, send the second message to the third network element to request to determine the data collection policy corresponding to the terminal, and send the registration response message including the data collection policy to the terminal. That is, the network element may receive the data reporting information of the terminal in a registration process of the terminal, so that the data reporting information of the terminal can be reported.

The network side device provided in this embodiment of this application can implement the processes implemented by the first network element in the foregoing method embodiment, and achieve a same technical effect. To avoid repetition, details are not described herein again.

In an example in which the network side device 1200 is the foregoing third network element, the network interface 1202 may be configured to receive a second message from a first network element, where the second message is used to request the network side device 1200 to determine a data collection policy corresponding to a terminal. The processor 1201 may be configured to determine the data collection policy based on the obtained data reporting information of the terminal, where the data reporting information is used to determine the data collection policy.

In a possible implementation, the data reporting information may include at least one of the following: data reporting capability information and data reporting preference information.

In a possible implementation, the data reporting capability information may include at least one of the following: first information, where the first information is used to indicate whether the terminal supports reporting data; first reporting mechanism information, where the first reporting mechanism information is used to indicate whether the terminal supports reporting data by using a first reporting mechanism, and the first reporting mechanism is a reporting mechanism in which a volume of to-be-reported data is greater than or equal to a first preset threshold; second reporting mechanism information, where the second reporting mechanism information is used to indicate whether the terminal supports reporting data by using a mute mechanism; type information of to-be-reported data, where the type information of the to-be-reported data is used to indicate a data type of to-be-reported data supported by the terminal; first reporting signature method information, where the first reporting signature method information is used to indicate a reporting signature method supported by the terminal; first state information of to-be-reported data, where the first state information of the to-be-reported data is used to indicate a state of to-be-reported data supported by the terminal; first reporting network type information, where the first reporting network information is used to indicate a type of an access network supported when the terminal reports data; reporting channel method information, where the reporting channel method information is used to indicate a reporting channel method supported when the terminal reports data; and first reporting time information, where the first reporting time information is used to indicate a data reporting time supported by the terminal.

In a possible implementation, the data reporting preference information may include at least one of the following: second reporting signature method information, where the second reporting signature method information is used to indicate a reporting signature method expected by the terminal; second state of to-be-reported data information, where the second state of to-be-reported data information is used to indicate a state of to-be-reported data expected by the terminal; second reporting network type information, where the second reporting network information is used to indicate a type of an access network expected when the terminal reports data; and second reporting time information, where the second reporting time information is used to indicate a data reporting time expected by the terminal.

In a possible implementation, the data collection policy may include at least one of the following: a data state of data; a signature method of data; a type of a network accessed by the terminal during data reporting; a reporting channel method supported by the terminal during data reporting; whether a data collection mechanism includes a first collection mechanism, where the first collection mechanism is a collection mechanism in which a volume of to-be-collected data is greater than or equal to a second preset threshold; and whether a data collection mechanism includes a mute mechanism.

In a possible implementation, the data reporting information may be obtained from at least one of the following: the second message and a second network element. The second network element is a network element responsible for data management.

In the network side device provided in this embodiment of this application, after receiving the second message that is sent by the first network element and that is used to request to determine the data collection policy corresponding to the terminal, the network side device may determine the data collection policy based on the obtained data reporting information of the terminal. That is, when determining the data collection policy corresponding to the terminal, the network side device may first obtain the data reporting information of the terminal, so that the data reporting information of the terminal can be reported.

The network side device provided in this embodiment of this application can implement the processes implemented by the third network element in the foregoing method embodiment, and achieve a same technical effect. To avoid repetition, details are not described herein again.

An embodiment of this application further provides a readable storage medium. The readable storage medium stores a program or an instruction. The program or the instruction is executed by a processor to implement the processes of the foregoing information reporting method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing information reporting method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing information reporting method embodiment, and a same technical effect can be achieved. To avoid repetition, details are not described herein again.

An embodiment of this application further provides a communication system, including a terminal, a first network side device, and a second network side device. The terminal may be configured to execute the steps of the foregoing method on the terminal side, the first network side device may be configured to execute the steps of the foregoing method on the first network element side, and the second network side device may be configured to execute the steps of the foregoing method on the second network element side.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a ...” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a more desirable manner of implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. An information reporting method, wherein the method comprises:
sending, by a terminal, a registration request message to request registration, wherein
the registration request message comprises data reporting information of the terminal, and the data reporting information is used to determine a data collection policy corresponding to the terminal.

2. The method according to claim 1, wherein the data reporting information comprises at least one of the following: data reporting capability information and data reporting preference information.

3. The method according to claim 2, wherein
the data reporting capability information comprises at least one of the following:
first information, wherein the first information is used to indicate whether the terminal supports reporting data;
first reporting mechanism information, wherein the first reporting mechanism information is used to indicate whether the terminal supports reporting data by using a first reporting mechanism, and the first reporting mechanism is a reporting mechanism in which a volume of to-be-reported data is greater than or equal to a first preset threshold;
second reporting mechanism information, wherein the second reporting mechanism information is used to indicate whether the terminal supports reporting data by using a mute mechanism;
type information of to-be-reported data, wherein the type information of the to-be-reported data is used to indicate a data type of to-be-reported data supported by the terminal;
first reporting signature method information, wherein the first reporting signature method information is used to indicate a reporting signature method supported by the terminal;
first state information of to-be-reported data, wherein the first state information of the to-be-reported data is used to indicate a state of to-be-reported data supported by the terminal;
first reporting network type information, wherein the first reporting network information is used to indicate a type of an access network supported when the terminal reports data;
reporting channel method information, wherein the reporting channel method information is used to indicate a reporting channel method supported when the terminal reports data; and
first reporting time information, wherein the first reporting time information is used to indicate a data reporting time supported by the terminal.

4. The method according to claim 3, wherein the first reporting mechanism information comprises at least one of the following: data format information of data that needs to be reported, data processing information of data that needs to be reported, and preset data volume threshold information, wherein
the preset data volume threshold information is used to indicate a minimum data volume that triggers to report data by using the first reporting mechanism.

5. The method according to claim 3, wherein the second reporting mechanism information comprises at least one of the following: data storage time information and data overflow operation information.

6. The method according to claim 3, wherein the reporting signature method comprises at least one of the following: an anonymous method, a semi-anonymous method, and a non-anonymous method.

7. The method according to claim 3, wherein the state of to-be-reported data comprises at least one of the following: an raw data state and a data state after data preprocessing.

8. The method according to claim 7, wherein
the data preprocessing comprises at least one of the following:
processing a data volume of data from a first data volume to a second data volume, wherein the first data volume is greater than the second data volume;
removing privacy information from data; and
processing a data format of data into a target data format.

9. The method according to claim 3, wherein the reporting channel method comprises at least one of the following: reporting through a user plane UP, reporting through a control plane CP, and reporting through an application function AF.

10. The method according to claim 2, wherein
the data reporting preference information comprises at least one of the following:
second reporting signature method information, wherein the second reporting signature method information is used to indicate a reporting signature method expected by the terminal;
second state of to-be-reported data information, wherein the second state of to-be-reported data information is used to indicate a state of to-be-reported data expected by the terminal;
second reporting network type information, wherein the second reporting network information is used to indicate a type of an access network expected when the terminal reports data; and
second reporting time information, wherein the second reporting time information is used to indicate a data reporting time expected by the terminal.

11. The method according to claim 1, wherein
the data collection policy comprises at least one of the following:
a data state of data;
a signature method of data;
a type of a network accessed by the terminal during data reporting;
a reporting channel method supported by the terminal during data reporting;
whether a data collection mechanism comprises a first collection mechanism, wherein the first collection mechanism is a collection mechanism in which a volume of to-be-collected data is greater than or equal to a second preset threshold; and
whether a data collection mechanism comprises a mute mechanism.

12. The method according to claim 1, wherein the registration request message further comprises identifier information of the terminal.

13. The method according to claim 1, wherein after the sending, by a terminal, a registration request message, the method further comprises:
receiving, by the terminal, a registration response message from a first network element, wherein
the registration response message comprises the data collection policy.

14. An information reporting method, wherein the method comprises:
receiving, by a first network element, a registration request message from a terminal, wherein the registration request message comprises data reporting information of the terminal, and the data reporting information is used to determine a data collection policy corresponding to the terminal;
sending, by the first network element, a first message to a second network element, and sending a second message to a third network element, wherein the first message comprises the data reporting information, and the second message is used to request the third network element to determine the data collection policy; and
sending, by the first network element, a registration response message to the terminal, wherein the registration response message comprises the determined data collection policy.

15. The method according to claim 14, wherein the second message comprises the data reporting information.

16. An information reporting method, wherein the method comprises:
receiving, by a third network element, a second message from a first network element, wherein the second message is used to request the third network element to determine a data collection policy corresponding to a terminal; and
determining, by the third network element, the data collection policy based on the obtained data reporting information of the terminal, wherein the data reporting information is used to determine the data collection policy.

17. The method according to claim 16, wherein the data reporting information is obtained from at least one of the following: the second message and a second network element, wherein
the second network element is a network element responsible for data management.

18. A terminal, comprising a processor and a memory, wherein the memory stores a program or an instruction that can be run on the processor, and the program or the instruction is executed by the processor to implement the steps of the information reporting method according to claim 1.

19. A network side device, comprising a processor and a memory, wherein the memory stores a program or an instruction that can be run on the processor, and the program or the instruction is executed by the processor to implement the steps of the information reporting method according to claim 14.

20. A network side device, comprising a processor and a memory, wherein the memory stores a program or an instruction that can be run on the processor, and the program or the instruction is executed by the processor to implement the steps of the information reporting method according to claim 16.
